(19) United States
(12) Patent Application Publication
(10) Pub. No.: US 2018/0203278 A1
(43) Pub. Date: Jul. 19, 2018

(54) TOUCH LIQUID CRYSTAL DISPLAY PANEL, COLOR FILTER SUBSTRATE AND TOUCH DISPLAY APPARATUS

(71) Applicant: Wuhan China Star Optoelectronics Technology Co., Ltd., Wuhan, Hubei (CN)

(72) Inventors: Man LI, Shenzhen, Guangdong (CN); Wei CHEN, Shenzhen, Guangdong (CN); Xingling GUO, Shenzhen, Guangdong (CN)

(73) Assignee: Wuhan China Star Optoelectronics Technology Co., Ltd., Wuhan, Hubei (CN)

(21) Appl. No.: 15/305,331

(22) PCT Filed: Sep. 18, 2016
(86) PCT No.: PCT/CN2016/099214

§ 371 Date: Oct. 19, 2016

(30) Foreign Application Priority Data
Aug. 24, 2016 (CN) 2016107177139

(51) Int. Cl. G02F 1/1333; G02F 1/1368; G02F 1/1335; G02F 1/1362; G09G 3/36; G06F 3/044; G06F 3/041

(52) U.S. Cl. CPC G02F 1/13338; G02F 1/1368; G02F 1/133514; G02F 2201/52; G09G 3/3611; G06F 3/044; G06F 3/0416; G02F 1/136286

(57) ABSTRACT

The present application discloses a touch liquid crystal display panel, color filter substrate and touch display apparatus, the display and touch of the touch liquid crystal display panel adapts the time sharing driving way, in a first time period of the cycle, the scanning for the n rows of the gate scanning lines is performed; in a second time period of the cycle, the touch detecting scanning is performed; and is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows, k≥2, n≥1. By the above approach, the present application can avoid dark line and improve the display quality.

### FIELD OF THE INVENTION

The present application relates to a touch display technology field, and more particularly to a touch liquid crystal display panel, color filter substrate and touch display apparatus.

### BACKGROUND OF THE INVENTION

With the intense degree of the competition of the smart phone market grow over deeper, for mobile phones and other small electronic products, the light and thin design has become one of the focus point of the mobile phone manufacturers currently, and one of the important approach to realize a slim display screen of the mobile phone is the adaption of the in-Cell touch panel liquid crystal display (TP LCD) structure to replace the original plug-in TP LCD structure.

The small and medium-sized low temperature polysilicon (LTPS) In-Cell structure LCD often adapt the scanning way of time sharing driving for the display and touch, as illustrated in FIG. 1: that is, after the gate line (gate) scanning of each N rows, it stops to proceed a part of the touch detection scanning, then the gate line is further scanning N rows, then proceed a part of the touch detection scanning, and so forth, until the completion of a display frame. The advantage of this is the less interference of the display and touch; but as shown in FIG. 2: in the period of the gate scanning line is stop and proceed the touch detection scanning, the source electrode is in the state of GND, which would cause leakage, after the touch detection scanning is complete, followed by scanning the gate scanning line of N+1th row, the source signal of the N+1th row is the situation as shown in FIG. 3 due to the leakage, the signal is distorted (the rising and falling edge are seriously time delayed), eventually leading to the pixels of the N+1th row cannot fully charged, the brightness of the N+1th row is dim in the display performance and forming a dark line.

Therefore, a new driver architecture is need to proposed to solve the dark line problem of the time sharing driving for the display and touch of the In cell LCD display module mentioned above.

### SUMMARY OF THE INVENTION

The embodiment of the present application provides a touch liquid crystal display panel, color filter substrate and touch display apparatus to solve the technical problem of dark line generated by the time sharing scanning of the display and touch.

In order to solve the problem mentioned above, the embodiment of the present application provides a touch liquid crystal display panel, the touch liquid crystal display panel including: a TFT substrate, a CF substrate disposed opposite to the TFT substrate, and a liquid crystal layer disposed between the TFT substrate and the CF substrate, the TFT substrate including a plurality rows of gate scanning lines, the CF substrate including a plurality rows of RGB color layer corresponding to the plurality of rows of the gate scanning lines, the display and touch of the touch liquid crystal display panel adapts the time sharing driving way, the scanning takes the time required for one frame of the image displayed as a cycle, in a first time period of the cycle, the scanning for the n rows of the gate scanning lines is performed, in a second time period of the cycle, the touch detecting scanning is performed; and is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows, k≥2, n≥1.

According a preferred embodiment of the present application, the thickness of the RGB color layer corresponding to the scan for the (k−1) n+1th row of the gate scanning line is having 2/3-4/5 times of the thickness of the RGB color layer in other rows.

According a preferred embodiment of the present application, the thickness of the RGB color layer corresponding to the scan for the (k−1) n+1th row are equal.

According a preferred embodiment of the present application, the touch liquid crystal display panel is a self capacitance type touch, a touch sensing electrode is disposed on a side of the TFT substrate adjacent to the CF substrate.

According a preferred embodiment of the present application, the touch liquid crystal display panel is a full in-cell touch liquid crystal display panel.

According a preferred embodiment of the present application, the RGB color layer is provided on one side of the CF substrate adjacent to the TFT substrate, each rows of the RGB color layer including a plurality of red color resistances, green color resistances and blue color resistances adjacent disposed.

In order to solve the problem mentioned above, the embodiment of the present application also provides a CF substrate, wherein the CF substrate is used in the touch liquid crystal display panel, the touch liquid crystal display panel further including a TFT substrate disposed opposite to the CF substrate, and a liquid crystal layer disposed between the TFT substrate and the CF substrate, the TFT substrate including a plurality rows of gate scanning lines, the CF substrate including a plurality rows of RGB color layer corresponding to the plurality of rows of the gate scanning lines, the display and touch of the touch liquid crystal display panel adapts the time sharing driving way, the scanning takes the time required for one frame of the image displayed as a cycle, in a first time period of the cycle, the scanning for the n rows of the gate scanning lines is performed, in a second time period of the cycle, the touch detecting scanning is performed; and is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows, k≥2, n≥1.

According a preferred embodiment of the present application, the thickness of the RGB color layer corresponding to the scan for the (k−1) n+1th row of the gate scanning line is having 2/3-4/5 times of the thickness of the RGB color layer in other rows.

According a preferred embodiment of the present application, the thickness of the RGB color layer corresponding to the scan for the (k−1) n+1th row are equal.

In order to solve the problem mentioned above, the embodiment of the present application also provides a touch display apparatus, therein the touch display apparatus including a backlight module and a touch liquid crystal display panel connected to the backlight module, wherein the touch liquid crystal display panel including: a TFT substrate, a CF substrate disposed opposite to the TFT substrate, and a liquid crystal layer disposed between the TFT substrate and the CF substrate, the TFT substrate including a plurality rows of gate scanning lines, the CF substrate including a plurality rows of RGB color layer corresponding to the plurality of rows of the gate scanning lines, the display and touch of the touch liquid crystal display panel adapts the time sharing driving way, the scanning takes the time required for one frame of the image displayed as a cycle, in a first time period of the cycle, the scanning for the n rows of the gate scanning lines is performed, in a second time period of the cycle, the touch detecting scanning is performed; and is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows, k≥2, n≥1.

According a preferred embodiment of the present application, the thickness of the RGB color layer corresponding to the scan for the (k−1) n+1th row of the gate scanning line is having 2/3-4/5 times of the thickness of the RGB color layer in other rows.

According a preferred embodiment of the present application, the thickness of the RGB color layer corresponding to the scan for the (k−1) n+1th row are equal.

According a preferred embodiment of the present application, wherein the touch liquid crystal display panel is a self capacitance type touch, a touch sensing electrode is disposed on a side of the TFT substrate adjacent to the CF substrate.

According a preferred embodiment of the present application, wherein the touch liquid crystal display panel is a full in-cell touch liquid crystal display panel.

According a preferred embodiment of the present application, the RGB color layer is provided on one side of the CF substrate adjacent to the TFT substrate, each rows of the RGB color layer including a plurality of red color resistances, green color resistances and blue color resistances adjacent disposed.

Comparing to the conventional technology, the touch liquid crystal display panel, color filter substrate and touch display apparatus provided in the present application is by setting the thickness of the RGB color layer corresponding to the scan for the (k−1) n+1th row of the gate scanning line smaller than the thickness of the RGB color layer of other rows, so that much light can be passed through, compared to the uniform thickness of the RGB color layer in the conventional technology with the status of having dark line, the present application can avoid the dark line caused and improve the display quality.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other figures according to these figures without paying the premise.

FIG. 1 illustrates a timing diagram of the time sharing driving of a touch liquid crystal display panel of the conventional technology;

FIG. 2 illustrates the principle schematic diagram of the dark line due to the time sharing driving shown in FIG. 1;

FIG. 3 illustrates the principle schematic diagram of the data delay due to the time sharing driving shown in FIG. 1;

FIG. 4 is a schematic diagram of the touch liquid crystal display panel in accordance with the embodiment of the present application;

FIG. 5 is a schematic diagram of the RGB color layers of the touch liquid crystal display panel shown in FIG. 4; and

FIG. 6 is a schematic diagram of the touch liquid crystal display apparatus in accordance with the embodiment of the present application.

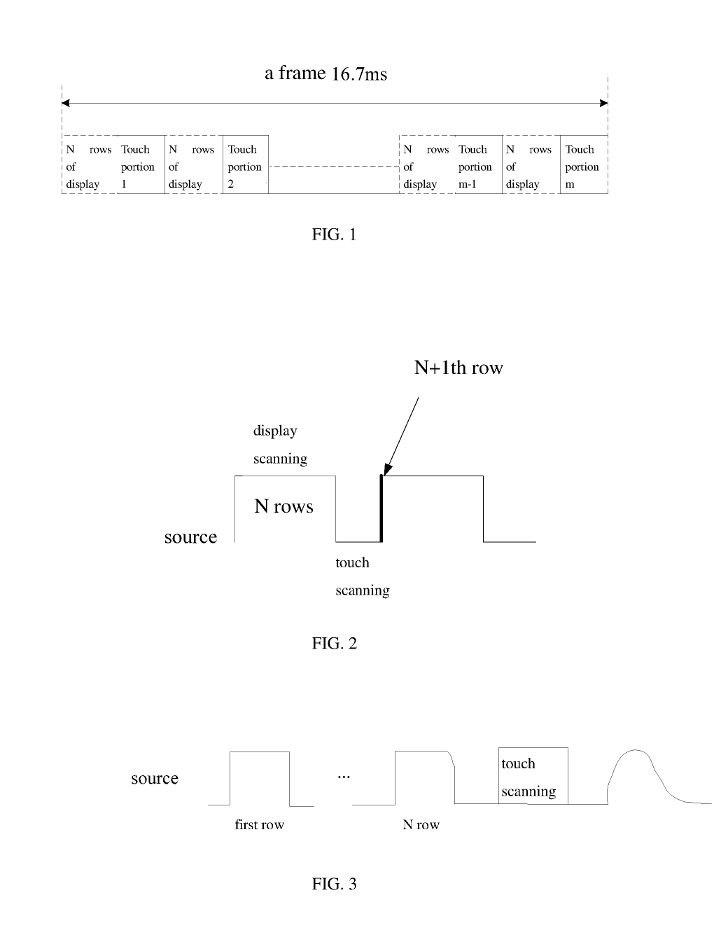

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained should be considered within the scope of protection of the present application.

Specifically, the terminologies in the embodiments of the present application are merely for describing the purpose of the certain embodiment, but not to limit the invention. Examples and the claims be implemented in the present application requires the use of the singular form of the book “an”, “the” and “the” are intend to include most forms unless the context clearly dictates otherwise. It should also be understood that the terminology used herein that “and/or” means and includes any or all possible combinations of one or more of the associated listed items.

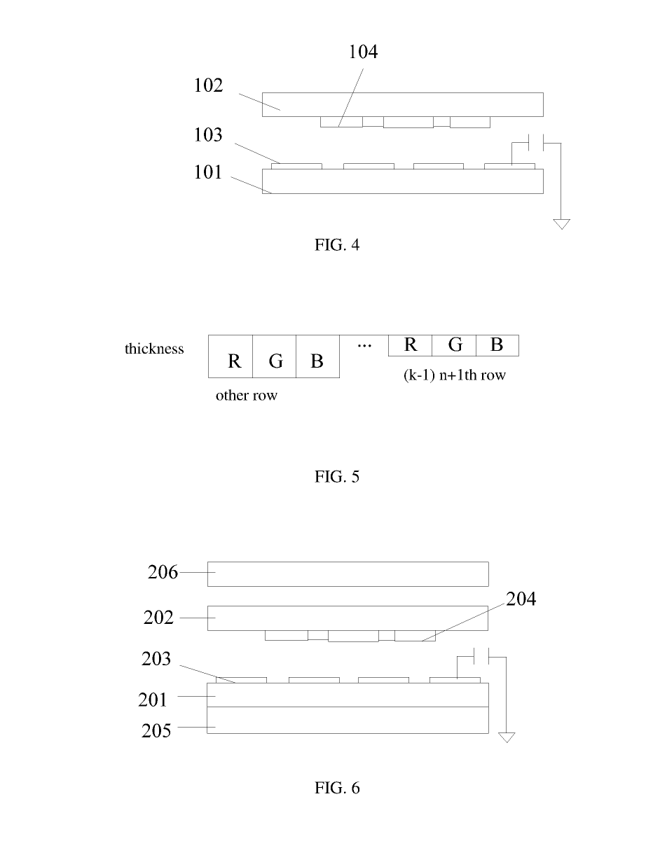

Referring to FIGS. 4-5, FIG. 4 is a schematic diagram of the touch liquid crystal display panel in accordance with the embodiment of the present application, FIG. 5 is a schematic diagram of the RGB color layers of the touch liquid crystal display panel shown in FIG. 4. The touch liquid crystal display panel of the present embodiment includes a thin film transistor, TFT substrate 101, a color filter, CF substrate 102 formed opposite to the TFT substrate 101, and a liquid crystal layer (not shown) formed between the TFT substrate 101 and the CF substrate 102. The touch liquid crystal display panel of the present embodiment is preferably a self capacitance type touch, the touch liquid crystal display panel is preferably a full in-cell touch liquid crystal display panel.

The TFT substrate 101 includes a plurality row of gate scanning lines (not shown), the plurality row of gate scanning lines is disposed paralleled. The TFT substrate 101 can further include a plurality rows of data lines intersecting with the plurality row of the gate scanning lines, and gate driver and the data driver for driving the gate scanning lines and the data lines, respectively, when performing driving, the gate driver provides a driving signal to the gate scanning lines, since when performing scanning for display, scanning the plurality row of the gate scanning lines is conventional technology, which will not repeat them here. A touch sensing electrode 103 is disposed in a side of the TFT substrate 101 adjacent to the CF substrate.

The CF substrate 102 includes a plurality row of RGB color layer 104 corresponding to the plurality row of the gate scanning lines, the RGB color layer is disposed in a side of the CF substrate 102 adjacent to the TFT substrate 101, each row of the RGB color layer 104 includes a plurality of red color resistances (R), green color resistances (G) and blue color resistances (B) adjacent disposed, when the light passes through the liquid crystal layer, continues pass through the RGB color layer 104, thereby displaying images of different colors on the screen, however, the inventors of the present application have found that when light passes through the RGB color layer 104 will lost the most brightness, that is, the transmittance rate of the RGB color layer 104 is inversely proportional to the thickness of the RGB color layer 104, that is the thicker the thickness of the RGB color layer 104, the less light can be passed through, thus by reducing the thickness of the RGB color layer 104 can make the more light passing through, and then make up the dark line dark line formed due to the time sharing driving in the conventional technology.

Specifically, the touch liquid crystal display panel in the present embodiment adapt the time sharing driving way for the display and touch, the scanning takes the time required for one frame of the image displayed as a cycle, in a first time period of the cycle, the scanning for the n rows of the gate scanning lines is performed, in a second time period of the cycle, the touch detecting scanning is performed; the scanning is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows (referring to FIG. 5), k≥2, n≥1, k and n are natural numbers. In the conventional technology, the display image is dark line of the pixel corresponding to the (k−1) n+1th row of the gate scanning line, while the present embodiment by reasonably reducing the thickness of the RGB colors layer 104, thereby increasing the volume of the passing light, and avoiding the generation of the dark line. Although the reducing of the thickness of the RGB color layer 104 has slight loss to the color saturation (NTSC) of the row, but the change of the color saturation is far less than the change of the transmittance, and the human eye to the sensitivity of brightness is much higher than the sensitivity to the chromaticity; on the other hand, since the thickness of the RGB color layer 104 had be only changed in a few rows of the entire panel, it is almost imperceptible to the human eye. It is worth mentioning that the thickness of the RGB color layer corresponding to the scan for the (k−1) n+1th row of the gate scanning line of the present embodiment is preferably having a 2/3-4/5 times of the thickness of the RGB color layer 104 in other rows, and the thickness of the RGB color layer corresponding to the scan for the (k−1) n+1th row are equal. Of course, in other embodiments, it can also be set according to the brightness requirement of the specific needs of the user, the present application is not limited to this.

The touch liquid crystal display panel provided by the present application is by setting the thickness of the RGB color layer corresponding to the scan for the (k−1) n+1th row of the gate scanning line smaller than the thickness of the RGB color layer of other rows, so that much light can be passed through, compared to the uniform thickness of the RGB color layer in the conventional technology with the status of having dark line, the present application can enhance the uniformity of the display in the condition of almost not affect the chromaticity, and to improve the generated dark line caused by the leakage of the stop for performing touch detection, and ultimately improve the display quality.

The present application also provides a color filter, CF substrate, the CF substrate is for a touch liquid crystal display panel, the touch liquid crystal display panel further includes a TFT substrate disposed opposite to the CF substrate, and a liquid crystal layer disposed between the TFT substrate and the CF substrate, the TFT substrate includes a plurality rows of gate scanning lines, the CF substrate includes a plurality rows of RGB color layer corresponding to the plurality of rows of the gate scanning lines, the display and touch of the touch liquid crystal display panel adapts the time sharing driving way, the scanning takes the time required for one frame of the image displayed as a cycle, in a first time period of the cycle, the scanning for the n rows of the gate scanning lines is performed, in a second time period of the cycle, the touch detecting scanning is performed; and is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows, k≥2, n≥1, k and n are natural numbers. Preferably, the thickness of the RGB color layer corresponding to the scan for the (k−1) n+1th row of the gate scanning line of the present embodiment is having a 2/3-4/5 times of the thickness of the RGB color layer 104 in other rows, and the thickness of the RGB color layer corresponding to the scan for the (k−1) n+1th row are equal. Of course, in other embodiments, it can also be set according to the brightness requirement of the specific needs of the user, the present application is not limited to this.

The CF substrate provided by the present application is by setting the thickness of the RGB color layer corresponding to the scan for the (k−1) n+1th row of the gate scanning line smaller than the thickness of the RGB color layer of other rows, so that much light can be passed through, compared to the uniform thickness of the RGB color layer in the conventional technology with the status of having dark line, the present application can enhance the uniformity of the display in the condition of almost not affect the chromaticity, and to improve the generated dark line caused by the leakage of the stop for performing touch detection, and ultimately improve the display quality.

Referring to FIG. 6, FIG. 6 is a schematic diagram of the touch liquid crystal display apparatus in accordance with the embodiment of the present application. In the present embodiment, the touch display apparatus includes a backlight module and the touch liquid crystal display panel in the embodiments described above connected to the backlight module, the touch liquid crystal display panel includes the TFT substrate 201, the CF substrate 202 disposed opposite to the TFT substrate 201, and a liquid crystal layer disposed between the TFT substrate 201 and the CF substrate 202, a touch sensing electrode 203 is disposed on a side of the TFT substrate 201 adjacent to the CF substrate 202, the CF substrate 202 includes a plurality rows of the RGB color layer 204 corresponding to a plurality rows of the gate scanning lines, the RGB color layer 204 is provided on one side of the CF substrate 202 adjacent to the TFT substrate 201, the backlight module includes backlight LED205 for providing light source to the touch display panel, the backlight LED205 is disposed underneath the TFT substrate 201, the touch display apparatus further includes a touch glass 206, the touch glass 206 is disposed on the CF substrate 202. The connecting relationship and the working principle between the components of the touch liquid crystal display panel can be referring to the embodiments above, and not repeating them here.

The touch liquid crystal display apparatus provided by the present application is by setting the thickness of the RGB color layer corresponding to the scan for the (k−1) n+1th row of the gate scanning line smaller than the thickness of the RGB color layer of other rows, so that much light can be passed through, compared to the uniform thickness of the RGB color layer in the conventional technology with the status of having dark line, the present application can enhance the uniformity of the display in the condition of almost not affect the chromaticity, and to improve the generated dark line caused by the leakage of the stop for performing touch detection, and ultimately improve the display quality.

Above are embodiments of the present application, which does not limit the scope of the present application. Any modifications, equivalent replacements or improvements within the spirit and principles of the embodiment described above should be covered by the protected scope of the invention.

What is claimed is:

1. A touch liquid crystal display panel, wherein the touch liquid crystal display panel comprising: a TFT substrate, a CF substrate disposed opposite to the TFT substrate, and a liquid crystal layer disposed between the TFT substrate and the CF substrate, the TFT substrate comprising a plurality rows of gate scanning lines, the CF substrate comprising a plurality rows of RGB color layer corresponding to the plurality of rows of the gate scanning lines, the display and touch of the touch liquid crystal display panel adapts the time sharing driving way, the scanning takes the time required for one frame of the image displayed as a cycle, in a first time period of the cycle, the scanning for the n rows of the gate scanning lines is performed, in a second time period of the cycle, the touch detecting scanning is performed; and is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows, k≥2, n≥1.

2. The touch liquid crystal display panel according to claim 1, wherein the thickness of the RGB color layer corresponding to the scan for the (k−1) n+1th row of the gate scanning line is having 2/3-4/5 times of the thickness of the RGB color layer in other rows.

3. The touch liquid crystal display panel according to claim 1, wherein the thickness of the RGB color layer corresponding to the scan for the (k−1) n+1th row are equal.

4. The touch liquid crystal display panel according to claim 1, wherein the touch liquid crystal display panel is a self capacitance type touch, a touch sensing electrode is disposed on a side of the TFT substrate adjacent to the CF substrate.

5. The touch liquid crystal display panel according to claim 1, wherein the touch liquid crystal display panel is a full in-cell touch liquid crystal display panel.

6. The touch liquid crystal display panel according to claim 1, wherein the RGB color layer is provided on one side of the CF substrate adjacent to the TFT substrate, each rows of the RGB color layer comprising a plurality of red color resistances, green color resistances and blue color resistances adjacent disposed.

7. A CF substrate, wherein the CF substrate is used in the touch liquid crystal display panel, the touch liquid crystal display panel further comprising a TFT substrate disposed opposite to the CF substrate, and a liquid crystal layer disposed between the TFT substrate and the CF substrate, the TFT substrate comprising a plurality rows of gate scanning lines, the CF substrate comprising a plurality rows of RGB color layer corresponding to the plurality of rows of the gate scanning lines, the display and touch of the touch liquid crystal display panel adapts the time sharing driving way, the scanning takes the time required for one frame of the image displayed as a cycle, in a first time period of the cycle, the scanning for the n rows of the gate scanning lines is performed, in a second time period of the cycle, the touch detecting scanning is performed; and is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows, k≥2, n≥1.

8. The CF substrate according to claim 7, wherein the thickness of the RGB color layer corresponding to the scan for the (k−1) n+1th row of the gate scanning line is having 2/3-4/5 times of the thickness of the RGB color layer in other rows.

9. The CF substrate according to claim 7, wherein the thickness of the RGB color layer corresponding to the scan for the (k−1) n+1th row are equal.

10. A touch display apparatus, therein the touch display apparatus comprising a backlight module and a touch liquid crystal display panel connected to the backlight module, wherein the touch liquid crystal display panel comprising: a TFT substrate, a CF substrate disposed opposite to the TFT substrate, and a liquid crystal layer disposed between the TFT substrate and the CF substrate, the TFT substrate comprising a plurality rows of gate scanning lines, the CF substrate comprising a plurality rows of RGB color layer corresponding to the plurality of rows of the gate scanning lines, the display and touch of the touch liquid crystal display panel adapts the time sharing driving way, the scanning takes the time required for one frame of the image displayed as a cycle, in a first time period of the cycle, the scanning for the n rows of the gate scanning lines is performed, in a second time period of the cycle, the touch detecting scanning is performed; and is performed sequentially alternatively until the completion of the frame of the image displayed, wherein k times scan the gate scanning line is performed in one cycle, the thickness of the RGB color layer corresponding to the scan for the (k−1) n+1th row of the gate scanning line is smaller than the thickness of the RGB color layer of other rows, k≥2, n≥1.

11. The touch display apparatus according to claim 10, wherein the thickness of the RGB color layer corresponding to the scan for the (k−1) n+1th row of the gate scanning line is having 2/3-4/5 times of the thickness of the RGB color layer in other rows.

12. The touch display apparatus according to claim 10, wherein the thickness of the RGB color layer corresponding to the scan for the (k−1) n+1th row are equal.

13. The touch display apparatus according to claim 10, wherein the touch liquid crystal display panel is a self capacitance type touch, a touch sensing electrode is disposed on a side of the TFT substrate adjacent to the CF substrate.

14. The touch display apparatus according to claim 10, wherein the touch liquid crystal display panel is a full in-cell touch liquid crystal display panel.

15. The touch display apparatus according to claim 10, wherein the RGB color layer is provided on one side of the CF substrate adjacent to the TFT substrate, each rows of the RGB color layer comprising a plurality of red color resistances, green color resistances and blue color resistances adjacent disposed.
